(19) United States
(12) Patent Application Publication
(10) Pub. No.: US 2018/0227760 A1
(43) Pub. Date: Aug. 9, 2018

(54) SELECTION OF GATEWAY NODE IN A COMMUNICATION SYSTEM

(71) Applicant: TELEFONAKTIEBOLAGET LM ERICSSON (PUBL), Stockholm (SE)

(72) Inventors: George FOTI, Dollard des Ormeaux (CA); Ralf KELLER, Würselen (DE)

(21) Appl. No.: 15/771,971

(22) PCT Filed: Oct. 28, 2016
(86) PCT No.: PCT/IB2016/056533

§ 371 Date: Apr. 27, 2018

Related U.S. Application Data
(60) Provisional application No. 62/250,144, filed on Nov. 3, 2015.

(51) Int. Cl. H04W 12/08; H04L 29/06; H04W 8/02

(52) U.S. Cl. CPC H04W 12/08; H04L 63/0884; H04W 60/00; H04L 63/0892; H04L 63/164; H04W 8/02

(57) ABSTRACT

Methods and systems are provided for the selection of a gateway node by a mobile terminal when the mobile terminal attaches to an untrusted radio access network while the mobile terminal is roaming out of its home communication network and into a visited communication network. Methods and systems are also provided for the handling of a connection request to a gateway node by a mobile terminal when the mobile terminal attaches to an untrusted radio access network while the mobile terminal is roaming out of its home communication network and into a visited communication network. Some embodiments may prevent or otherwise block a mobile terminal from connecting to a gateway node in its home communication network while the mobile terminal is roaming out of its home communication network and into a visited communication network when the mobile terminal is not authorized or allowed to do so.

### CROSS-REFERENCE TO RELATED APPLICATIONS

The present application claims the benefits of priority of U.S. Provisional Patent Application No. 62/250,144, entitled “SELECTION OF GATEWAY NODE IN A COMMUNICATION SYSTEM”, and filed on Nov. 3, 2015, at the United States Patent and Trademark Office; the content of which is incorporated herein by reference.

### TECHNICAL FIELD

The present disclosure generally relates to the selection of network nodes in communication systems, and more particularly to the selection of gateway nodes in communication systems.

### BACKGROUND

In communication systems based on 3GPP standards, wireless access to the core network, generally referred to the evolved packet core, EPC, is typically provided by the evolved universal terrestrial radio access network, EUTRAN. EUTRAN is more commonly known as the LTE radio access network. However, the EPC has been developed to also support other 3GPP radio access technologies such as GSM EDGE radio access network, GERAN, and UMTS terrestrial radio access network, UTRAN, as well as non-3GPP radio access technologies such as wireless local area networks operating under the IEEE 802.11 standard, i.e. WiFi.

3GPP TS 23.402 describes the basic network architecture required to provide access to the EPC via a non-3GPP radio access technology. As depicted in FIG. 1, a non-3GPP radio access network can be either trusted or untrusted. The decision to qualify a given non-3GPP radio access network as trusted or untrusted is made by the operator of the 3GPP communication system to which access is sought. When a given non-3GPP radio access network is qualified as trusted, the non-3GPP radio access network can directly access the packet data network gateway, PGW, located in the EPC, which provides access to a packet data network, e.g. the Internet, and other packet-based services, e.g. IP multimedia subsystem, IMS. This is illustrated in FIG. 1 by the direct logical link between the trusted non-3GPP radio access network and the PGW. However, when the non-3GPP radio access network is considered untrusted, access to the PGW is provided via an evolved packet data gateway, ePDG, also located in the EPC. As shown in FIG. 1, the ePDG acts as an intermediate gateway node between the untrusted non-3GPP radio access network and the PGW. In that sense, the ePDG is generally responsible for providing a secured tunnel between the mobile terminal or user equipment, UE, attached to the untrusted non-3GPP radio access network, and the ePDG.

When the mobile terminal seeking access to the EPC via the untrusted non-3GPP radio access network is otherwise located or attached to its home 3GPP communication system, also referred to as a home public mobile network, HPMN, ePDG selection is not an issue as the mobile terminal will normally connect to the ePDG located in its home 3GPP communication system, i.e. in its HPMN.

However, when a mobile terminal roams into a visited 3GPP communication system, also referred to as a visited public mobile network, VPMN, access to the EPC via an untrusted non-3GPP radio access network is generally determined by policies decided by the operator of the HPMN of the mobile terminal or by policies decided by the manufacturers. 3GPP TS 23.402 provides that a mobile terminal can be configured to select an ePDG either by static configuration, or dynamically. For instance, the HPMN operator may prefer a home routed solution in which the mobile terminal is statically configured to connect to the ePDG located in the HPMN, which then connects to the PGW also located in the HPMN. However, if the mobile terminal is configured to dynamically select the ePDG, the mobile terminal may retrieve the address of the ePDG located in the VPMN, via a DNS request for instance, and then connect to it.

Still, regulations in certain regions or countries may require that a roaming mobile terminal selects an ePDG in the visited communication network. This is due, for instance, to the fact that operators providing calls and other voice services in the VPMN may be subject to service-based lawful interception and data retention. If the selected ePDG is located in the home communication network (i.e. HPMN), then an operator might not be able to fulfill its legal obligations regarding service-based lawful interception and data retention on roaming mobile terminals.

### SUMMARY

Some embodiments provide methods and systems for the selection of a gateway node by a mobile terminal when the mobile terminal attaches to an untrusted radio access network while the mobile terminal is roaming out of its home communication network and into a visited communication network. Some embodiments provide methods and systems for the handling of a connection request to a gateway node by a mobile terminal when the mobile terminal attaches to an untrusted radio access network while the mobile terminal is roaming out of its home communication network and into a visited communication network. Some embodiments may prevent or otherwise block a mobile terminal from connecting to a gateway node in its home communication network while the mobile terminal is roaming out of its home communication network and into a visited communication network when the mobile terminal is not authorized or allowed to do so.

According to one aspect, some embodiments include a method in a mobile terminal associated with a home communication network when the mobile terminal is in a visited communication network. The method comprises receiving an identification of the visited network, and receiving an indication to connect to a gateway node in the visited network upon attachment to an untrusted access network. The method also comprises attaching to an untrusted access network, as a function of the indication to connect to a gateway node in the visited communication network upon attachment to an untrusted access network, transmitting a connection request to the gateway node in the visited network via the untrusted access network, the connection request comprising at least the identification of the visited network and an identification of the mobile terminal, and receiving a connection response from the gateway node in the visited network, the connection response comprising at least an indication that connection to the gateway node in the visited network is authorized.

According to another aspect, some embodiments include a method in a mobile terminal associated with a home communication network when the mobile terminal is in a visited communication network. The method comprises receiving an identification of the visited network, and receiving an indication to connect to a gateway node in the visited network upon attachment to an untrusted access network. The method also comprises attaching to an untrusted access network, transmitting a connection request to a gateway node in the home network via the untrusted access network, the connection request comprising at least the identification of the visited network and an identification of the mobile terminal, and receiving a connection response from the gateway node in the home network, the connection response comprising at least an indication that connection to the gateway node in the home network is not authorized.

In some embodiments, the connection response may comprise, or further comprise, an indication to connect to a gateway node in the visited network. In some embodiments, the connection response may comprise, or further comprise, an identification of the gateway node in the visited network.

In some embodiments, the method may further comprise transmitting a subsequent connection request to the gateway node in the visited network via the untrusted access network responsive to receiving the connection response comprising at least the indication that connection to the gateway node in the home network is not authorized. In such embodiments, the subsequent connection request may comprise at least the identification of the visited network and the identification of the mobile terminal.

According to another aspect, some embodiments include a mobile terminal configured to perform one or more mobile terminal functionalities as described herein. The mobile terminal comprises interfacing circuitry configured to communicate with one or more communication networks and/or with one or more network nodes, and processing circuitry operatively connected to the interfacing circuitry, the processing circuitry being configured to perform mobile terminal functionalities as described herein.

According to another aspect, some embodiments include a mobile terminal configured to perform one or more functionalities as described herein. The mobile terminal comprises a receiving module configured to receive an identification of a visited network and a receiving module configured to receive an indication to connect to a gateway node of the visited network upon attaching to an untrusted radio access network. The mobile terminal also comprises an attaching module configured to attach to an untrusted radio access network. The mobile terminal also comprises a transmitting module which, in some embodiments, is configured to transmit a connection request to a gateway node in the visited network, while in other embodiments, is configured to transmit a connection request to a gateway node in a home network. The mobile terminal also comprises a receiving module which, in some embodiments, is configured to receive a connection response from the gateway node in the visited network, while in other embodiments, is configured to receive a connection response from the gateway node in the home network.

According to another aspect, some embodiments include a non-transitory computer-readable medium storing a computer program product comprising instructions which, upon being executed by processing circuitry (e.g., a processor) of the mobile terminal, configure the processing circuitry to perform one or more mobile terminal functionalities as described herein.

According to another aspect, some embodiments include a method to handle a connection request in a gateway node of a communication network. The method comprises receiving a connection request from a mobile terminal associated with a home communication network but located in a visited communication network, the mobile terminal being attached to an untrusted access network, the connection request comprising at least an identification of the visited network and an identification of the mobile terminal. The method also comprises transmitting an authentication and authorization request to an authentication server, the authentication and authorization request comprising at least the identification of the visited network and the identification of the mobile terminal. The method also comprises receiving an authentication and authorization response from the authentication server, the authentication and authorization response comprising at least an indication as to whether connection from the mobile terminal to the gateway node is authorized. The method also comprises transmitting a connection response to the mobile terminal, the connection response comprising at least the indication as to whether the mobile terminal is authorized to connect to the gateway node.

In some embodiments, in which the gateway node is located in the home network, the indication as to whether the mobile terminal is authorized to connect to the gateway node indicates that the mobile terminal is not authorized to connect to the gateway node. In some embodiments, the connection response may comprise, or further comprise, an indication to connect to a gateway node in the visited network. In some embodiments, the connection response may comprise, or further comprise, an identification of the gateway node in the visited network.

According to another aspect, some embodiments include a gateway node configured to perform one or more gateway node functionalities as described herein. The gateway node comprises interfacing circuitry configured to communicate with one or more communication networks and/or with one or more network nodes, and processing circuitry operatively connected to the interfacing circuitry, the processing circuitry being configured to perform gateway node functionalities as described herein.

According to another aspect, some embodiments include a gateway node configured to perform one or more gateway node functionalities as described herein. The gateway node comprises a receiving module configured to receive a connection request from a mobile terminal associated with a home communication network but located in a visited communication network, the mobile terminal being attached to an untrusted access network, the connection request comprising at least an identification of the visited network and an identification of the mobile terminal. The gateway node also comprises a transmitting module configured to transmit an authentication and authorization request to an authentication server, the authentication and authorization request comprising at least the identification of the visited network and the identification of the mobile terminal, and a receiving module configured to receive an authentication and authorization response from the authentication server, the authentication and authorization response comprising at least an indication as to whether the mobile terminal is authorized to connect to the gateway node. The gateway node also comprises a transmitting module configured to transmit a connection response to the mobile terminal, the connection response comprising at least the indication as to whether the mobile terminal is authorized to connect to the gateway node.

According to another aspect, some embodiments include a non-transitory computer-readable medium storing a computer program product comprising instructions which, upon being executed by processing circuitry (e.g., a processor) of the gateway node, configure the processing circuitry to perform one or more gateway node functionalities as described herein.

According to another aspect, some embodiments include a method to handle a connection request in an authentication server of a communication network. The method comprises receiving an authentication and authorization request from a gateway node, the authentication and authorization request comprising at least an identification of a mobile terminal associated with a home communication network but located in a visited communication network, the mobile terminal being attached to an untrusted access network, and an identification of the visited communication network. The method also comprises determining whether the mobile terminal is authorized to connect to the gateway node based at least in part on the identification of the visited network, and at least one connection rule. The method also comprises transmitting an authentication and authorization response to the gateway node, the authentication and authorization response comprising at least an indication as to whether the mobile terminal is authorized to connect to the gateway node.

In some embodiments, the method may further comprise retrieving the at least one connection rule from an authentication server located in the visited network.

In some embodiments, in which the gateway node is located in the home network, the indication as to whether the mobile terminal is authorized to connect to the gateway node indicates that the mobile terminal is not authorized to connect to the gateway node. In some embodiments, the authentication and authorization response may comprise, or further comprise, an indication to connect to a gateway node in the visited network. In some embodiments, the authentication and authorization response may comprise, or further comprise, an identification of a gateway node in the visited network.

In some embodiments, in which the gateway node is located in the visited network, the indication as to whether the mobile terminal is authorized to connect to the gateway node indicates that the mobile terminal is authorized to connect to the gateway node.

According to another aspect, some embodiments include an authentication server configured to perform one or more authentication server functionalities as described herein. The authentication server comprises interfacing circuitry configured to communicate with one or more communication networks and/or with one or more network nodes, and processing circuitry operatively connected to the interfacing circuitry, the processing circuitry being configured to perform authentication server functionalities as described herein.

According to another aspect, some embodiments include an authentication server configured to perform one or more authentication server functionalities as described herein. The authentication server comprises a receiving module configured to receive an authentication and authorization request from a gateway node, the authentication and authorization request comprising at least an identification of a mobile terminal associated with a home communication network but located in a visited communication network, the mobile terminal being attached to an untrusted access network, and an identification of the visited communication network. The authentication server also comprises a determining module configured to determine whether the mobile terminal is authorized to connect to the gateway node based at least in part on the identification of the visited network, and at least one connection rule. The authentication server also comprises a transmitting module configured to transmit an authentication and authorization response to the gateway node comprising an indication as to whether the mobile terminal is authorized to connect to the gateway node.

According to another aspect, some embodiments include a non-transitory computer-readable medium storing a computer program product comprising instructions which, upon being executed by processing circuitry (e.g., a processor) of the authentication server, configure the processing circuitry to perform one or more authentication server functionalities as described herein.

Other aspects and features will become apparent to those ordinarily skilled in the art upon review of the following description of exemplary embodiments in conjunction with the accompanying figures

### BRIEF DESCRIPTION OF THE DRAWINGS

A more complete understanding of the embodiments described herein, and the attendant advantages and features thereof, will be more readily understood by reference to the following detailed description when considered in conjunction with the accompanying drawings wherein:

FIG. 1 illustrates a block diagram of a simplified network architecture in accordance with 3GPP standards.

FIG. 2 illustrates a block diagram of a simplified network architecture in accordance with some embodiments.

FIG. 3 illustrates a signaling diagram in accordance with some embodiments.

FIG. 4 illustrates another signaling diagram in accordance with some embodiments.

FIG. 5 illustrates a flow chart of a process to connect to a gateway node in accordance with some embodiments.

FIG. 6 illustrates another flow chart of a process to connect to a gateway node in accordance with some embodiments.

FIG. 7 illustrates a flow chart of a process to handle connection request in a gateway node in accordance with some embodiments.

FIG. 8 illustrates a flow chart of a process to handle connection request in an authentication server in accordance with some embodiments.

FIG. 9 illustrates a block diagram of a mobile terminal in accordance with some embodiments.

FIG. 10 illustrates another block diagram of a mobile terminal in accordance with some embodiments.

FIG. 11 illustrates a block diagram of a gateway node in accordance with some embodiments.

FIG. 12 illustrates another block diagram of a gateway node in accordance with some embodiments.

FIG. 13 illustrates a block diagram of an authentication server in accordance with some embodiments.

FIG. 14 illustrates another block diagram of an authentication server in accordance with some embodiments

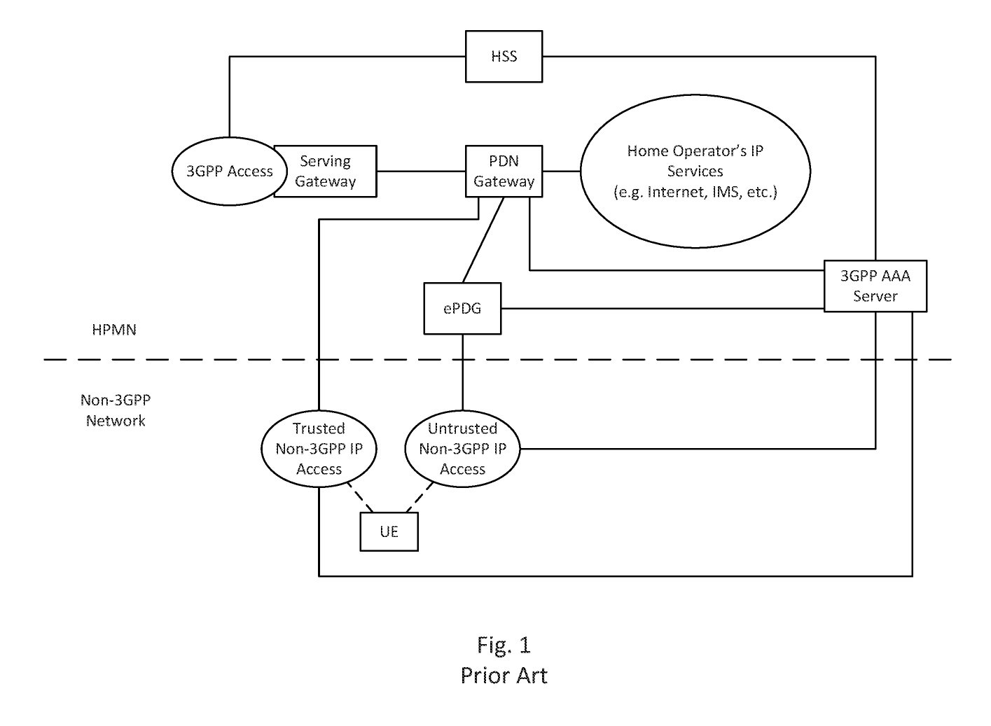

### DETAILED DESCRIPTION

The embodiments set forth below represent information to enable those skilled in the art to practice the embodiments. Upon reading the following description in light of the accompanying drawing figures, those skilled in the art will understand the concepts of the description and will recognize applications of these concepts not particularly addressed herein. It should be understood that these concepts and applications fall within the scope of the description.

In the following description, numerous specific details are set forth. However, it is understood that embodiments of the disclosure may be practiced without these specific details. In other instances, well-known circuits, structures, and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

In the specification, the terms “coupled” and “connected,” along with their derivatives, may be used. It should be understood that these terms are not intended as synonyms for each other. “Coupled” is used to indicate that two or more elements, which may or may not be in direct physical or electrical contact with each other, cooperate or interact with each other. “Connected” is used to indicate the establishment of communication between two or more elements that are coupled with each other.

Some embodiments provide methods and systems for the selection of a gateway node by a mobile terminal when the mobile terminal attaches to an untrusted radio access network while the mobile terminal is roaming out of its home communication network and into a visited communication network. Some embodiments provide methods and systems for the handling of a connection request by a mobile terminal to a gateway node when the mobile terminal attaches to an untrusted radio access network while the mobile terminal is roaming out of its home communication network and into a visited communication network. Some embodiments may advantageously prevent or otherwise block a mobile terminal from connecting to a gateway node in its home communication network when the mobile terminal is not authorized or allowed to do so.

Several embodiments will be described in the context of 3GPP and IETF standards and as such, the terminology of these standards will be used for the sake of clarity. However, references to 3GPP and/or IETF standards and to their terminologies should not be construed as limiting the scope of the present disclosure to such standards.

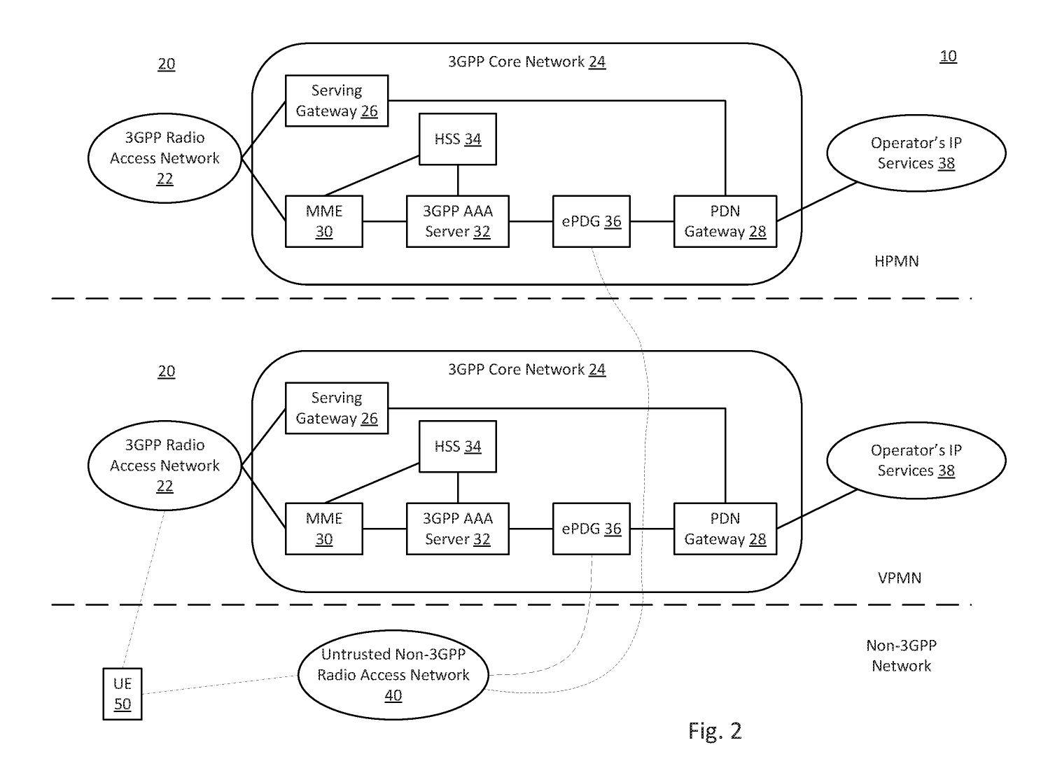

Referring now to FIG. 2, a simplified communication system 10 in which embodiments may be deployed is depicted. Communication system 10 comprises two communication networks 20, one being generally referred to as a home public mobile network, HPMN, and the other being generally referred to as a visited public mobile network, VPMN, and an untrusted radio access network 40.

Communication networks 20 each comprise a radio access network 22, e.g. a 3GPP radio access network such as LTE, and a core network 24, e.g. a 3GPP core network such as EPC. The radio access network 22 provides the air interface, via a plurality of base stations, e.g. eNBs, with the various mobile terminals, generally referred to as UEs in 3GPP standards, located within their coverage areas. For its part, the core network 24 comprises a series of network nodes which perform various functions for the communication network 20.

Understandably, the notion of home network and visited network is usually determined from the perspective of a given mobile terminal 50. The home network 20 of a mobile terminal 50 is the network the mobile terminal is a subscriber of, it is the network where the mobile terminal's subscriber profile is held. For its part, the visited network 20 of a mobile terminal 50 is a network the mobile terminal is not a subscriber of but from which the mobile terminal can still receive services in view of, for example, roaming agreements between the home network 20 and the visited network 20. In that regard, the home network 20 of one mobile terminal 50 can be the visited network 20 of another mobile terminal 50.

When a mobile terminal 50 of a home network 20 roams into a visited network such as visited network 20, the mobile terminal 50 attaches to the visited network 20 via the radio access network 22 of the visited network 20. Upon attachment to the visited network 20, the mobile terminal 50 exchanges credentials and other information with the mobile management entity, MME, 30 of the visited network 20. During this network attachment exchange, the mobile terminal 50 transmits its identification, e.g. its international mobile subscriber identity, IMSI, its mobile station international subscriber directory number, MSISDN, etc. and receives the identification of the visited network, e.g. the cell global identifier, CGI, the VPMN ID, etc.

Despite being attached to the visited network 20, the mobile terminal 50 may attach to the untrusted radio access network 40. In the context of 3GPP standards, such an untrusted radio access network is generally referred to as an untrusted non-3GPP radio access network to distinguish it from the 3GPP radio access network 22 such as a LTE radio access network.

According to current 3GPP standards, when a mobile terminal wishes to access a 3GPP network via an untrusted non-3GPP radio access network, the mobile terminal must connect, via the untrusted non-3GPP radio access network, to a gateway node 36 which is generally referred to as an evolved packet data gateway, ePDG, in 3GPP standard parlance.

An ePDG is generally responsible for providing a secured and encrypted communication tunnel between the mobile terminal, which is attached to an untrusted non-3GPP radio access network, and the packet data network gateway, PGW, located in the 3GPP core network.

Both the home network 20 of the mobile terminal 50 and the visited network 20 have an ePDG 36, respectively a home ePDG 36 and a visited ePDG 36. As per section 4.5.4 of 3GPP TS 23.402, a mobile terminal may select an ePDG either by static configuration or dynamically.

This selection configuration, static or dynamic, is generally decided by the operator of the home network of the mobile terminal. In some circumstances however, regulations in certain regions or countries may require that a mobile terminal roaming into a visited network always selects the ePDG in the visited domain. This may be due, for instance, to legal obligations of network operators to be able to perform lawful interception and data retention for mobile terminals within their respective network domain. If the mobile terminal has been configured to connect with the ePDG of its home network, then the operator of the visited network may be unable to fulfill its legal obligations with respect to lawful interception and data retention.

Hence, according to some embodiments, a mobile terminal roaming into a visited network may be instructed to connect to the ePDG of the visited network independently of ePDG connection configuration present on the mobile terminal. According to some embodiments, a mobile terminal may alternatively or additionally be prevented from connecting to the ePDG of its home network when roaming into a visited network.

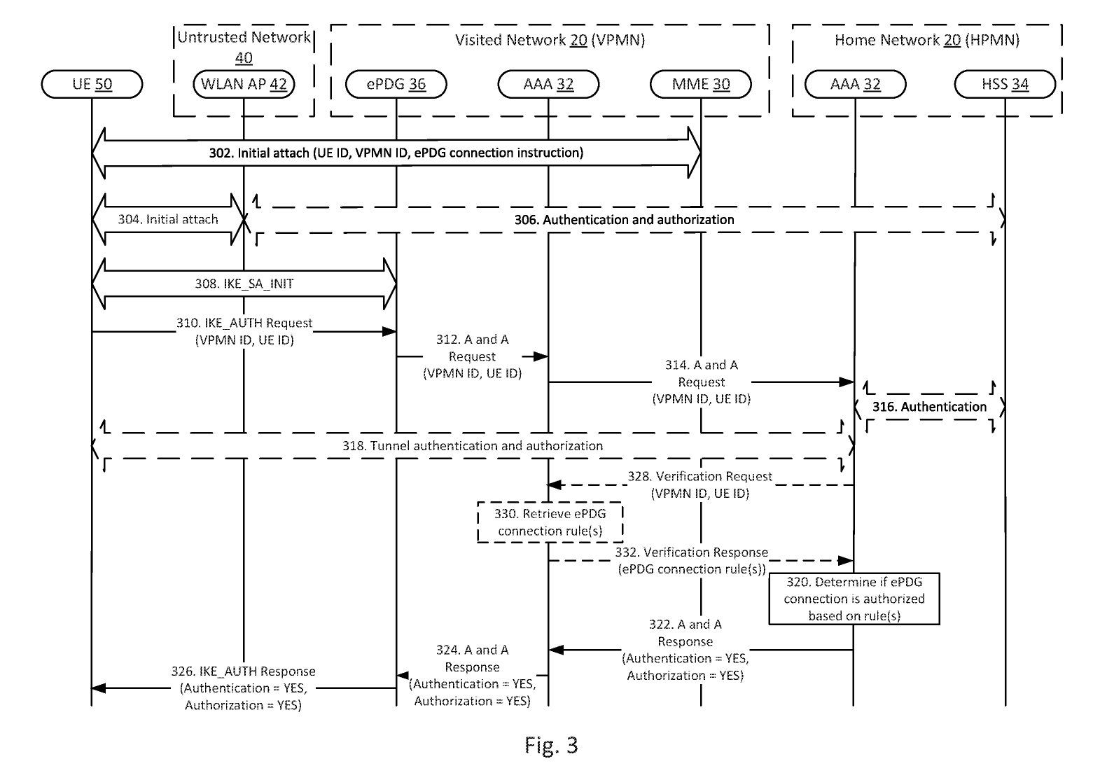

Referring now to FIG. 3, a signaling diagram of an embodiment is illustrated. The mobile terminal 50 first attaches to the visited 3GPP network, VPMN, in which it is roaming (step 302). During the attachment procedure, mobile terminal 50 exchanges credentials and information with the MME 30 of the visited 3GPP network 20. An example of this attachment procedure is described in section 5.3.2.1 of 3GPP TS 23.401. Regardless, during this exchange, mobile terminal 50 transmits its identification, generally in the form of an IMSI or a MSISDN and receives the identification of the visited 3GPP network 20, generally in the form of a VPMN ID or any other identifying information that includes the VPMN ID or can be used to derive it. For instance, MME 30 could transmit the cell global identification, CGI, as defined in section 4.3.1 of 3GPP TS 23.003, which comprises the mobile country code, MCC, the mobile network code, MNC, the location area identification, LAC, and the cell identity, CI. The combination of the MCC and MNC is, in some embodiments, the PMN ID. The mobile terminal 50 also receives an indication from the MME 30 to connect to the ePDG 36 in the visited 3GPP network upon attachment to an untrusted non-3GPP radio access network 40.

Mobile terminal 50 then attaches or otherwise connect to an untrusted non-3GPP radio access network 40 such as a wireless local area network, WLAN, which may operate according to the IEEE 802.11 standards (step 304). Such an untrusted non-3GPP radio access network may be referred to as a WiFi network comprising one or more access point, AP, 42. During the attachment procedure between the mobile terminal 50 and the untrusted non-3GPP radio access network 40, the untrusted non-3GPP radio access network 40 may optionally authenticate and authorize the mobile terminal 50 by exchanging information and credentials with a home subscriber server, HSS, 34 (step 306).

Upon successful attachment to the untrusted non-3GPP radio access network 40, the mobile terminal 50 handshakes with the ePDG 36 (step 308) located in the visited network 20 prior to the establishment of a secured communication tunnel, e.g. an IPSec tunnel. In some embodiments, the mobile terminal 50 may have selected the ePDG 36 of the visited 3GPP network is response to the indication to connect to the ePDG 36 in the visited network upon attachment to an untrusted non-3GPP radio access network 40 received during the initial attach to the visited network 20. In some embodiments, the mobile terminal 50 may have selected the ePDG 36 of the visited 3GPP network as per home network operator's policy or as instructed per the indication from the MME.

This initial handshaking exchange between the mobile terminal 50 and the ePDG 36 is used, for instance, to negotiate cryptographic algorithms which may be needed during the establishment of the secured communication tunnel. Though various handshaking exchanges could be used, in some embodiments, an IKE_SA_INIT exchange, as described in IETF RFC 5996, is used.

Mobile terminal 50 then sends a connection request to the ePDG 36 (step 310). In some embodiments, this connection request may be an IKE_AUTH Request as described in IETF RFC 5996 and in 3GPP TS 33.402. Regardless, the connection request comprises at least the identification of the visited network, the VPMN ID, and an identification of the mobile terminal (e.g. IMSI, MSISDN, MAC address, local IP address, etc.), and possibly the access point name, APN, to which the mobile terminal 50 wishes to connect. For example, if mobile terminal 50 attaches to the untrusted non-3GPP radio access network 40 to perform a Voice over WiFi call, mobile terminal 50 may include the APN of the IMS network which will service the Voice over WiFi call.

Upon receiving the connection request from the mobile terminal 50, the ePDG 36 transmits an authentication and authorization (referred to as “A and A” in the figures) request to an authentication server 32 in the visited network 20 (step 312) which further forwards the authentication and authorization request to an authentication server 32 in the home network (step 314). The authentication and authorization request comprises at least the identification of the visited network, and the identification of the mobile terminal. The authentication and authorization request seeks to authenticate the identity of the mobile terminal and to determine whether the mobile terminal 50 is authorized to connect to the ePDG 36. In the present embodiment, the authentication server 32 is an authentication, authorization and accounting, AAA, server 32.

To authenticate mobile terminal 50, the home AAA server 32 exchanges authentication challenges and responses with it (step 318). In some embodiments, this authentication exchange may be the authentication exchange described in section 8.2.2 of 3GPP TS 33.402. In some embodiments, the home AAA server 32 may additionally communicate with the HSS 34 to authenticate the mobile terminal 50 (step 316). Before, during or after the authentication exchange, home AAA server 32 determines whether connection to the ePDG 36 is authorized or otherwise allowed based on one or more rules regarding connection to ePDG from roaming mobile terminals (step 320).

An example of a rule regarding connection to ePDG from roaming mobile terminals may include:

if VPMN ID of mobile terminal == PMN ID of ePDG
then connection is authorized;
else connection is denied

If the home AAA server 32 determines that mobile terminal 50 is authorized to connect to the ePDG, because, for instance, the VPMN ID of mobile terminal 50 is the same as the PMN ID of the visited ePDG 36, the home AAA server 32 returns an authentication and authorization response comprising an indication that authentication was successful and that authorization was successful to the visited AAA server 32 (step 322) which further forwards it to the ePDG 36 (step 324).

The ePDG 36 then relays the indication that authentication was successful and that authorization was successful to the mobile terminal 50 via a connection response (step 326). In some embodiments, the connection response may be an IKE_AUTH Response as described in IETF RFC 5996 and in 3GPP TS 33.402. Regardless, at this point, the secured tunnel between mobile terminal 50 and ePDG 36 in the visited network is established.

In some embodiments, the home AAA server 32 may not know or otherwise be aware of the particular rule or rules to be applied to a roaming mobile terminal in a given visited network 20. In such cases, prior to determining whether connection to the home ePDG 36 is authorized or otherwise allowed for the roaming mobile terminal 50 (step 320), the home AAA server 32 retrieves the applicable rule or rules from the AAA server 32 in the identified visited network 20. To do so, in some embodiments, the home AAA server 32 sends a verification request to the visited AAA server 32 (step 328), the verification request comprising the identification of the visited network (e.g. the VPMN ID) and the identification of the mobile terminal. The visited AAA server 32 then retrieves the applicable rule or rules (step 330), if any, and sends back a verification response to the AAA server 32 in the home network 20, the verification response comprising the one or more rules, if any, or at least an identification thereof (step 332). Upon receiving the one or more rules or identification thereof, the home AAA server 32 performs the determination as described above (step 320).

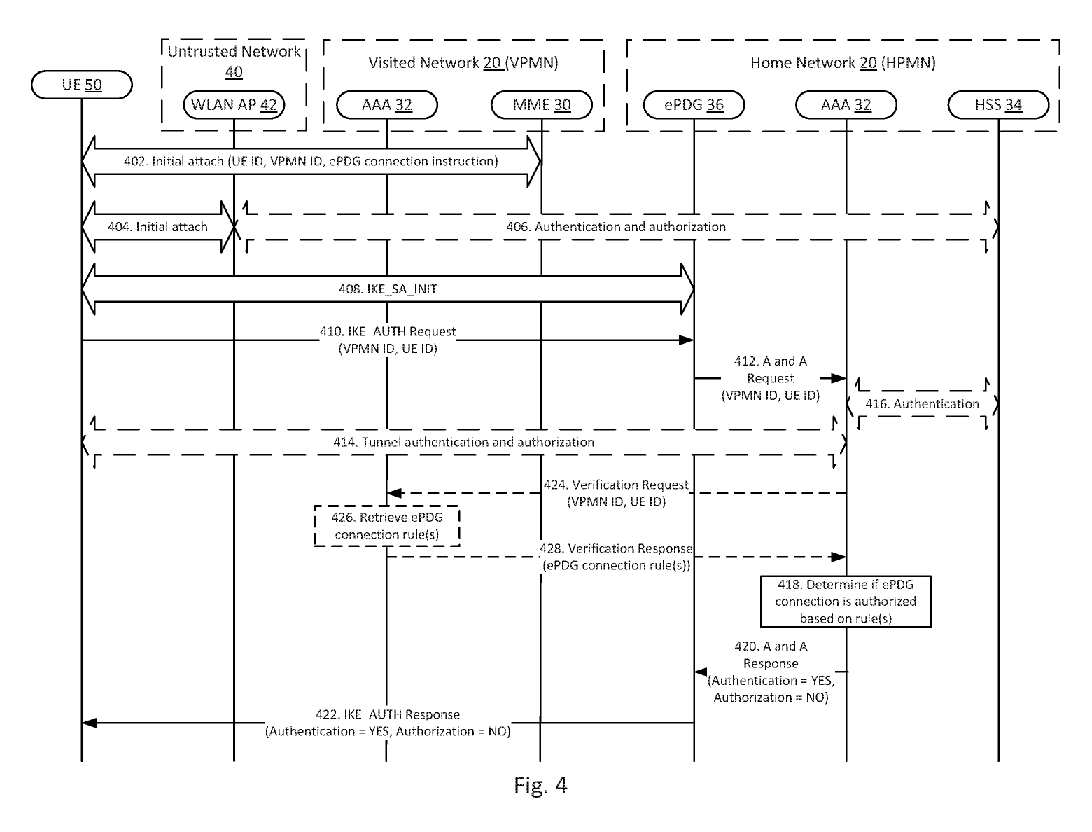

However, it is possible that the mobile terminal 50, despite roaming into a visited 3GPP network, and despite being instructed to connect to the ePDG of the visited 3GPP network upon attaching to an untrusted non-3GPP radio access network, tries to establish a secured tunnel with the ePDG of its home network. This may be because mobile terminal 50 is not configured to process ePDG connection instruction received from visited 3GPP networks, or because mobile terminal 50 has been previously configured, by the operator of its home network for instance, to always connect to the home ePDG, even when roaming, and despite instructions to the contrary received from visited 3GPP networks. FIG. 4 is a signaling diagram illustrating such an embodiment.

As in FIG. 3, in the embodiment of FIG. 4, the mobile terminal 50 first attaches to the visited network 20 (step 402), then attaches or otherwise connects to the untrusted non-3GPP radio access network 40 (step 404). The untrusted non-3GPP radio access network 40 may then optionally authenticate the mobile terminal with a HSS 34 (step 406).

Once mobile terminal 50 is attached to the untrusted non-3GPP radio access network 40, mobile terminal 50 handshakes with the ePDG 36 of its home network 20 according, for instance, to internal configurations of the mobile terminal 50 (step 408). As already mentioned, this initial handshaking exchange between the mobile terminal 50 and the ePDG 36 is used, for instance, to negotiate cryptographic algorithms which will be needed during the establishment of the secured communication tunnel. Though various handshaking exchanges could be used, in some embodiments, an IKE_SA_INIT exchange, as described in IETF RFC 5996, is used.

Upon completion of this initial handshaking exchange, mobile terminal 50 transmits a connection request to the home ePDG 36 (step 410). The connection request comprises at least the identification of the visited network, and the identification of the mobile terminal, and possibly the access point name, APN, to which the mobile terminal 50 wishes to connect. In some embodiments, this connection request may be an IKE_AUTH Request as described in IETF RFC 5996 and in 3GPP TS 33.402.

Upon receiving the connection request from the mobile terminal 50, the home ePDG 36 transmits an authentication and authorization request to the AAA server 32 in the home network (step 412). The authentication and authorization request comprises at least the identification of the visited network, and the identification of the mobile terminal.

To authenticate the mobile terminal 50, the AAA server 32 exchanges authentication challenges and responses with the mobile terminal 50 (step 414). In some embodiments, this authentication exchange may be the authentication exchange described in section 8.2.2 of 3GPP TS 33.402. In some embodiments, the home AAA 32 may additionally communicate with the HSS 34 to authenticate the mobile terminal 50 (step 416). Regardless, before, during or after the authentication exchange, the AAA server 32 determines whether connection to the home ePDG 36 is authorized or otherwise allowed based at least in part on the identification of the visited network (e.g. VPMN ID) provided by the mobile terminal and at least one rule regarding connection to a home ePDG from a roaming mobile terminal (step 418). In some embodiments, the home AAA server 32 may be aware of such rules for given VPMN IDs. For instance, the AAA server 32 may have been previously provided with such rules or may have retrieved such rules from AAA servers 32 of other networks 20. Regardless, in some embodiments, the home AAA server 32 may determine on its own whether or not mobile terminal 50 is authorized to connect to the home ePDG 36 despite being in a visited network. If AAA server 32 determines that mobile terminal 50 is authorized to connect to the home ePDG 36, AAA server 32 returns an authentication and authorization response comprising an indication that authentication was successful and that authorization was successful to the home ePDG 36. The home ePDG 36 then relays the indication that authentication was successful and that authorization was successful to the mobile terminal 50. At this point, the secured tunnel between mobile terminal 50 and ePDG in the home network is established.

However, if the home AAA server 32 determines, based at least in part on the identification of the visited network, VPMN ID, and at least one rule regarding connection to ePDGs from roaming mobile terminals, that mobile terminal 50 is not authorized to connect to the home ePDG 36, the home AAA server 32 then returns an authentication and authorization response comprising an indication that authentication was successful but that authorization was denied to the home ePDG (step 420). The home ePDG 36 then relays a connection response to the mobile terminal 50, the connection response comprising the indication that authentication was successful but that authorization was denied (step 422). In some embodiments, the connection response may be an IKE_AUTH Response as described in IETF RFC 5996 and in 3GPP TS 33.402. Regardless, at this point, the procedure to establish a secured tunnel between mobile terminal 50 and the home ePDG 36 is stopped.

Though not shown, in some embodiments, the authentication and authorization response (step 420) and the connection response (step 422) may further comprise an indication to connect to a ePDG 36 in the visited network 20 and also possibly an identification of the ePDG 36 in the visited network 20. In such embodiments, the mobile terminal 50 may, responsive to receiving a connection response from the ePDG 36 in the home network 20 indicating to connect to an ePDG 36 in the visited network 20, transmit a subsequent connection request to the ePDG 36 in the visited network 20 via the untrusted access network 40, the subsequent connection request comprising at least the identification of the visited network and the identification of the mobile terminal.

In some embodiments, the indication that authentication was successful but that authorization was denied may be carried by an AT_NOTIFICATION payload as described in IETF RFC 4187. In that sense, the AT_NOTIFICATION payload may carry the generic error message or code “1026” corresponding to “User has been temporarily denied access to the requested service.” as specified in IETF RFC 4187. Alternatively, the AT_NOTIFICATION payload may carry a specific error message or code corresponding to “User has been denied access to the requested service.”

In some embodiments, the home AAA server 32 may not know or otherwise be aware of the particular rule or rules to be applied to a roaming mobile terminal in a given visited network 20. In such cases, prior to determining whether connection to the home ePDG 36 is authorized or otherwise allowed for the roaming mobile terminal 50 (step 418), the home AAA server 32 retrieves the applicable rule or rules from the AAA server 32 in the identified visited network 20. To do so, in some embodiments, the home AAA server 32 sends a verification request to the visited AAA server 32 (step 424), the verification request comprising the identification of the visited network (e.g. the VPMN ID) and the identification of the mobile terminal. The visited AAA server 32 then retrieves the applicable rule or rules (step 426), if any, and sends back a verification response to the AAA server 32 in the home network 20, the verification response comprising the one or more rules, if any, or at least an identification thereof (step 428). Upon receiving the one or more rules or identification thereof, the home AAA server 32 performs the determination as described above (step 418).

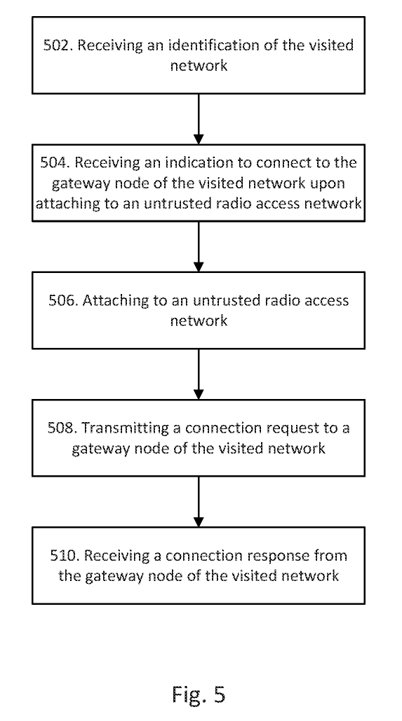

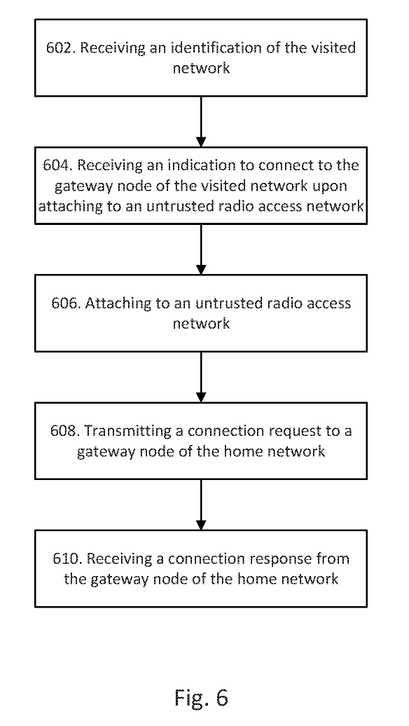

FIGS. 5 and 6 are flowchart of exemplary processes for connecting to an ePDG (i.e. a gateway node) when a mobile terminal is roaming in a visited network. Beginning with FIG. 5, the process starts with the mobile terminal receiving an identification of the visited network (block 502), and receiving an indication to connect to the ePDG of the visited network upon attaching to an untrusted radio access network (block 504). Though shown as two different steps, the reception of the identification of the visited network and of the indication to connect to the ePDG of the visited network upon attaching to an untrusted radio access network may occur within the same message or during the same message exchange (e.g. during the initial attach to the visited network). Then, mobile terminal attaches to an untrusted radio access network (block 506). Mobile terminal then transmits a connection request to the ePDG of the visited network (block 508), the connection request generally comprising at least the identification of the visited network, to which the mobile terminal is attached, and an identification of the mobile terminal. In some embodiments, the mobile terminal may transmit a connection request to the ePDG of the visited network because it has been instructed to do so by the MME, or other controlling node, of the visited network, that is in response to, or as a function of, the indication to connect to the ePDG of the visited network upon attaching to an untrusted radio access network. In some other embodiments, the mobile terminal may transmit a connection request to the ePDG of the visited network because it has been configured, by the operator of its home network, to connect to the ePDG of the visited network when roaming. Regardless, mobile terminal subsequently receives a connection response from the ePDG of the visited 3GPP network (block 510), the connection response comprising an indication as to whether the mobile terminal is authorized to connect with the ePDG.

Turning now to FIG. 6, the process generally starts as in FIG. 5 with mobile terminal 50 receiving an identification of the visited network 20 (block 602), and receiving an indication to connect to the ePDG of the visited network upon attaching to an untrusted radio access network (block 604). Again, though shown as two different steps, the reception of the identification of the visited network and of the indication to connect to the ePDG of the visited network upon attaching to an untrusted radio access network may occur within the same message or during the same message exchange (e.g. during the initial attach to the visited network). Then, mobile terminal attaches to an untrusted radio access network (block 606). However, in this case, mobile terminal transmits a connection request to the ePDG of its home network (block 608), the connection request generally comprising at least the identification of the visited network, to which the mobile terminal is attached, and an identification of the mobile terminal. In some embodiments, the mobile terminal may transmit a connection request to the ePDG of its home network because it is not configured or otherwise capable to process the indication received from the visited network to connect to the ePDG of the visited network upon attaching to untrusted radio access network or because it has been configured to do so by the operator of its home network. Regardless, the mobile terminal subsequently receives a connection response from the ePDG of the home network (block 610), the connection response comprising an indication as to whether the mobile terminal is authorized to connect with the ePDG.

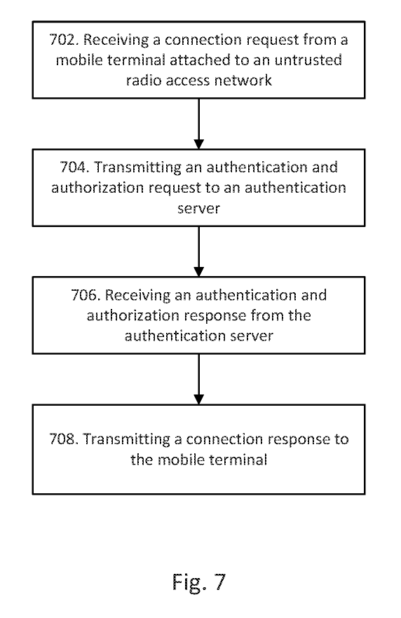

FIG. 7 illustrates a flowchart of an exemplary process for handling connection requests received by an ePDG from roaming mobile terminals attached to untrusted radio access networks. The process starts with the ePDG receiving a connection request from the mobile terminal attached to the untrusted radio access network (block 702). The connection request generally comprises at least an identification of the visited network, to which the mobile terminal is attached, and an identification of the mobile terminal. The ePDG then transmits an authentication and authorization request to the AAA server (i.e. an authentication server) (block 704). The authentication and authorization request also generally comprises at least the identification of the visited network, to which the mobile terminal is attached, and the identification of the mobile terminal. The ePDG then receives an authentication and authorization response from the AAA server (block 706). The authentication and authorization response generally comprises an indication as to whether the mobile terminal is authorized to connect with the ePDG based at least in part on the identification of the visited network and at least one connection rule. The ePDG then transmits a connection response to the mobile terminal comprising the indication as to whether the mobile terminal is authorized to connect with the ePDG (block 708).

In embodiments where the ePDG is located in the visited network, the ePDG transmits the authentication and authorization request to the AAA server of the visited network, which further interacts with the AAA of the home network. In embodiments where the ePDG is located in the home network, the ePDG transmits the authentication and authorization request to the AAA server of the home network. In that sense, as indicated above, the notion of home network and visited network is relative to the mobile terminal. For instance, the home network of one mobile terminal may be a visited network for another mobile terminal.

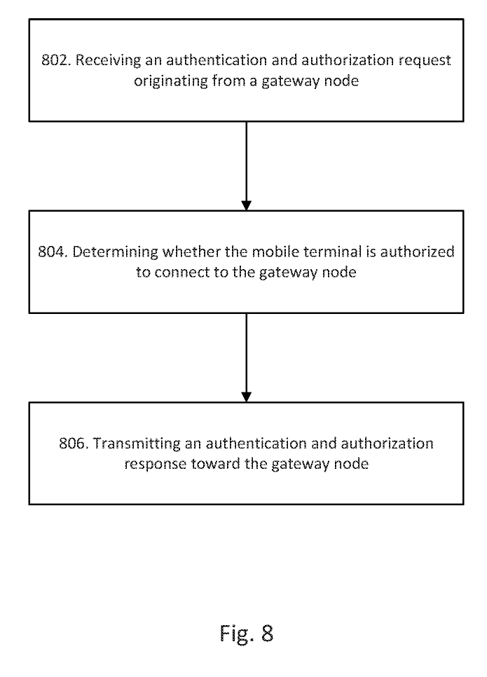

FIG. 8 illustrates a flowchart of an exemplary process for handling connection requests received by ePDG from roaming mobile terminals attached to untrusted radio access networks. The process starts with the AAA server receiving an authentication and authorization request originating from the ePDG, the authentication and authorization request comprising at least an identification of the visited network, to which the mobile terminal is attached, and an identification of the mobile terminal attached to the untrusted radio access network (block 802). The AAA server then determines whether the mobile terminal is authorized to connect to the ePDG based at least in part on the identification of the visited network, to which the mobile terminal is attached, and on at least one ePDG connection rule (block 804). The AAA server then transmits an authentication and authorization response toward the ePDG comprising an indication as to whether the mobile terminal is authorized to connect to the ePDG (block 806). The indication as to whether the mobile terminal is authorized to connect to the ePDG is based at least in part on the identification of the visited network, to which the mobile terminal is attached, and on the at least one ePDG connection rule.

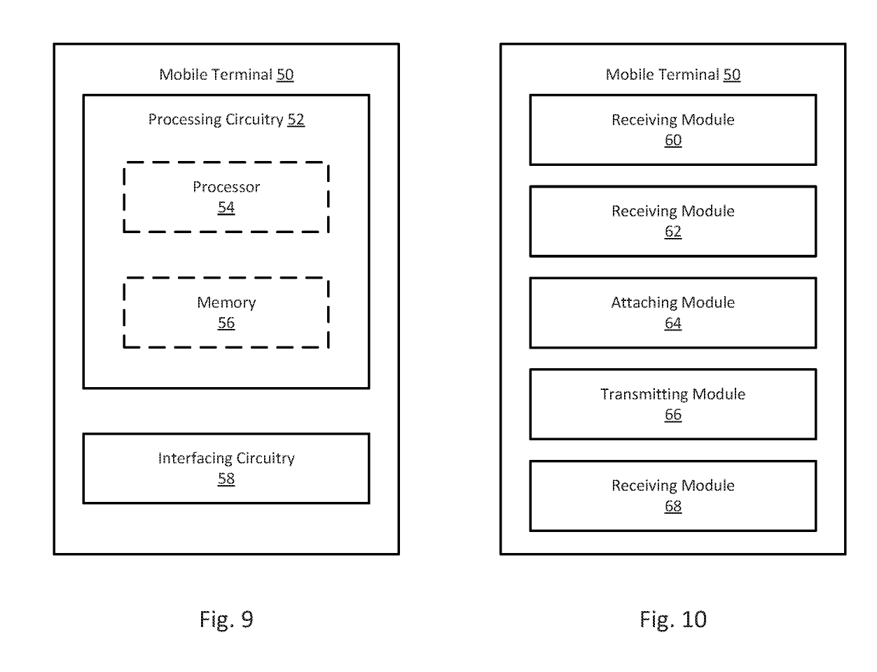

Referring now to FIGS. 9 to 10, block diagrams of embodiments of mobile terminal 50 that can be used in one or more of the non-limiting example embodiments described are illustrated. In FIG. 9, the mobile terminal 50 comprises processing circuitry 52, which may comprise one or more processors 54, hardware circuits (e.g. application-specific integrated circuit (ASIC), field-programmable gate array (FPGA), etc.), firmware, or a combination thereof. Processing circuitry 52, in some embodiments, operates in conjunction with memory 56 that stores instructions for execution by one or more processors 54 of the processing circuitry 52. Memory 56 may comprise one or more volatile and/or non-volatile memory devices. Program code for controlling the overall operations of the mobile terminal is, in some embodiments, stored in a non-volatile memory, such as a read-only memory or flash memory. Temporary data generated during operations may be stored in random access memory. The program code stored in memory, when executed by the processing circuitry 52, causes the processing circuitry 52 to perform the methods described above in relation to the mobile terminal 50. The mobile terminal 50 also comprises interfacing circuitry 58 for communicating with one or more networks and/or one or more network nodes (e.g. ePDG, AAA, MME, etc.). The interfacing circuitry 58 may include transceiver circuitry that, for example, comprise transmitter circuitry and receiver circuitry that operate according to known communication standards (e.g. 3GPP standards, IEEE standards).

In FIG. 10, the mobile terminal 50 is shown as comprising a plurality of functional modules which may, in some embodiments, be implemented as hardware, software, or combination thereof. Regardless, in FIG. 10, mobile terminal 50 comprises a receiving module 60 configured to receive an identification of the visited network and a receiving module 62 configured to receive an indication to connect to the gateway node of the visited network upon attaching to an untrusted radio access network. The mobile terminal 50 also comprises an attaching module 64 configured to attach to an untrusted radio access network. Mobile terminal 50 also comprises a transmitting module 66 configured to transmit a connection request to a gateway node, the connection request comprising at least the identification of the visited network and an identification of the mobile terminal. In some embodiments, the transmitting module 66 is configured to transmit a connection request to a gateway node of the visited network, while in other embodiments, the transmitting module 66 is configured to transmit a connection request to a gateway node of the home network. Mobile terminal 50 also comprises a receiving module 68 which, in some embodiments, is configured to receive a connection response from the gateway node of the visited network, while in other embodiments, is configured to receive a connection response from the gateway node of the home network. The connection response generally comprises an indication as to whether the mobile terminal is authorized to connect to the gateway node. In some embodiments, one or more of the various attaching, transmitting and receiving modules may be combined or implemented as a single interfacing module.

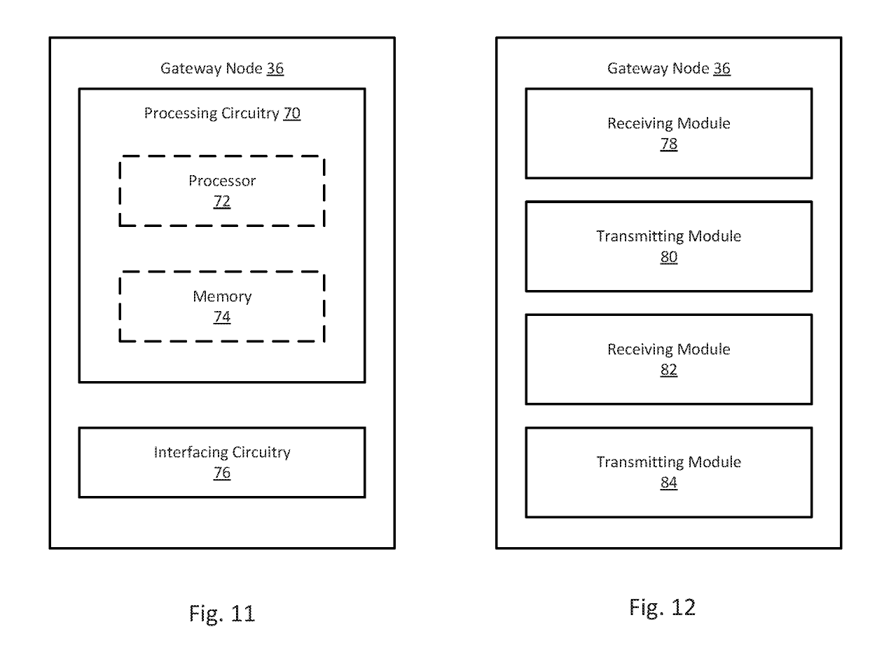

Referring now to FIGS. 11 and 12, block diagrams of embodiments of a gateway node such as an ePDG that can be used in one or more of the non-limiting example embodiments described are illustrated. In FIG. 11, the gateway node 36 comprises processing circuitry 70, which may comprise one or more processors 72, hardware circuits (e.g. application-specific integrated circuit (ASIC), field-programmable gate array (FPGA), etc.), firmware, or a combination thereof. Processing circuitry 70, in some embodiments, operates in conjunction with memory 74 that stores instructions for execution by one or more processors 72 of the processing circuitry 70. Memory 74 may comprise one or more volatile and/or non-volatile memory devices. Program code for controlling the overall operations of the gateway node is, in some embodiments, stored in a non-volatile memory, such as a read-only memory or flash memory. Temporary data generated during operations may be stored in random access memory. The program code stored in memory, when executed by the processing circuitry 70, causes the processing circuitry 70 to perform the methods described above in relation to the gateway node 36. The gateway node 36 also comprises interfacing circuitry 76 for communicating with one or more networks and/or one or more network nodes (e.g. UE, AAA, MME, etc.). The interfacing circuitry 76 may include transceiver circuitry that, for example, comprise transmitter circuitry and receiver circuitry that operate according to known communication standards (e.g. 3GPP standards, IEEE standards).

In FIG. 12, the gateway node is shown as comprising a plurality of functional modules which may, in some embodiments, be implemented as hardware or software, or combination thereof. For instance, in some embodiments, the gateway node comprises a receiving module 78 configured to receive a connection request from a mobile terminal associated with a home communication network but located in a visited communication network, the mobile terminal being attached to an untrusted access network, the connection request comprising at least an identification of the visited network. The gateway node also comprises a transmitting module 80 configured to transmit an authentication and authorization request to an authentication server, the authentication and authorization request comprising at least the identification of the visited network and an identification of the mobile terminal, and a receiving module 82 configured to receive an authentication and authorization response from the authentication server, the authentication and authorization response comprising at least an indication as to whether the mobile terminal is authorized to connect to the gateway node. The gateway node also comprises a transmitting module 84 configured to transmit a connection response to the mobile terminal, the connection response comprising at least the indication as to whether the mobile terminal is authorized to connect to the gateway node. In some embodiments, one or more of the various transmitting and receiving modules may be combined or implemented as one or more interfacing module or modules.

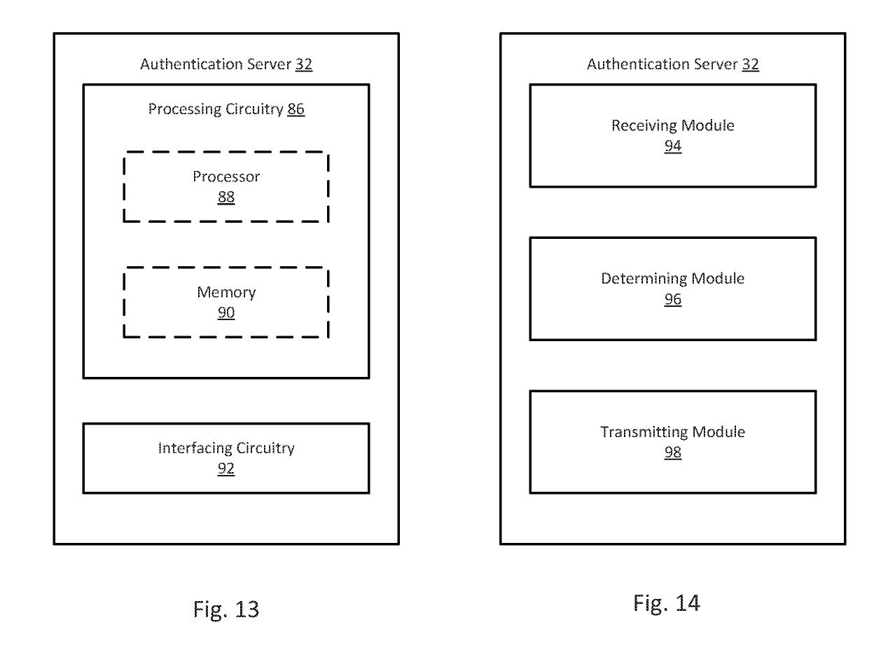

Referring now to FIGS. 13 and 14, block diagrams of embodiments of an authentication server such as an AAA server that can be used in one or more of the non-limiting example embodiments described are illustrated. In FIG. 13, the authentication server 32 comprises processing circuitry 86, which may comprise one or more processors 88, hardware circuits (e.g. application-specific integrated circuit (ASIC), field-programmable gate array (FPGA), etc.), firmware, or a combination thereof. Processing circuitry 86, in some embodiments, operates in conjunction with memory 90 that stores instructions for execution by one or more processors 88 of the processing circuitry 86. Memory 90 may comprise one or more volatile and/or non-volatile memory devices. Program code for controlling the overall operations of the authentication server 32 is, in some embodiments, stored in a non-volatile memory, such as a read-only memory or flash memory. Temporary data generated during operations may be stored in random access memory. The program code stored in memory, when executed by the processing circuitry 86 causes the processing circuitry 86 to perform the methods described above in relation to the authentication server 32. The authentication server 32 also comprises interfacing circuitry 92 for communicating with one or more networks and/or one or more network nodes (e.g. UE, ePDG, AAA, MME, etc.). The interfacing circuitry 92 may include transceiver circuitry that, for example, comprise transmitter circuitry and receiver circuitry that operate according to known communication standards (e.g. 3GPP standards, IEEE standards).

In FIG. 14, the authentication server is shown as comprising a plurality of functional modules which may, in some embodiments, be implemented as hardware or software, or combination thereof. For instance, in some embodiments, the authentication server comprises a receiving module 94 configured to receive an authentication and authorization request from a gateway node, the authentication and authorization request comprising at least an identification of a mobile terminal attached to an untrusted radio access network and an identification of a visited network to which the mobile terminal is attached. The authentication server also comprises a determining module 96 configured to determine whether the mobile terminal is authorized to connect to the gateway node based at least in part on the identification of the visited network to which the mobile terminal is attached, and at least one connection rule. The authentication server also comprises a transmitting module 98 configured to transmit an authentication and authorization response to the gateway node comprising an indication as to whether the mobile terminal is authorized to connect to the gateway node. In some embodiments, the transmitting and receiving modules may be combined or implemented as one interfacing module.

Those skilled in the art will appreciate that mobile terminal is a non-limiting expression comprising any device equipped with a wireless interface allowing for receiving wireless signals from a radio network node. Some non-limiting examples of a mobile terminal, in a general sense, are a user equipment (UE), a laptop, a wireless device, a machine-to-machine (M2M) device, a device capable of device-to-device (D2D) communication, etc.

Some embodiments may be represented as a non-transitory software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to one or more of the described embodiments. Those of ordinary skill in the art will appreciate that other instructions and operations necessary to implement the described embodiments may also be stored on the machine-readable medium. Software running from the machine-readable medium may interface with circuitry to perform the described tasks.

The above-described embodiments are intended to be examples only. Alterations, modifications and variations may be effected to the particular embodiments by those of skill in the art without departing from the scope of the disclosure.

1. A method in a mobile terminal associated with a home communication network when the mobile terminal is in a visited communication network, the method comprising:
receiving an identification of the visited communication network;
receiving an indication to connect with a gateway node in the visited communication network upon attachment to an untrusted access network;
attaching to an untrusted access network;
transmitting a connection request to a gateway node in the home communication network via the untrusted access network, the connection request comprising at least the identification of the visited communication network and an identification of the mobile terminal;
receiving a connection response from the gateway node in the home communication network, the connection response comprising at least an indication that connection to the gateway node in the home communication network is not authorized.

2. A method as claimed in claim 1, wherein the connection response further comprises an indication to connect to a gateway node in the visited communication network.

3. A method as claimed in claim 1, wherein the connection response further comprises an identification of the gateway node in the visited communication network.

4. A method as claimed in claim 1, further comprising, responsive to receiving a connection response from the gateway node in the home communication network, transmitting a subsequent connection request to the gateway node in the visited communication network via the untrusted access network, the subsequent connection request comprising at least the identification of the visited communication network and the identification of the mobile terminal.

5. A method in a mobile terminal associated with a home communication network when the mobile terminal is in a visited communication network, the method comprising:
receiving an identification of the visited communication network;
receiving an indication to connect with a gateway node in the visited communication network upon attachment to an untrusted access network;
attaching to an untrusted access network;
as a function of the indication to connect with a gateway node in the visited communication network upon attachment to an untrusted access network, transmitting a connection request to a gateway node in the visited communication network via the untrusted access network, the connection request comprising at least the identification of the visited communication network and an identification of the mobile terminal;
receiving a connection response from the gateway node in the visited communication network, the connection response comprising at least an indication that connection to the gateway node in the visited communication network is authorized.

6. A mobile terminal comprising:
interfacing circuitry; and
processing circuitry configured to, when the mobile terminal is located in a visited communication network while being associated with a home communication network:
receive an identification of the visited communication network;
receive an indication to connect with a gateway node in the visited communication network upon attachment to an untrusted access network;
attach to an untrusted access network;
transmit a connection request to a gateway node in the home communication network via the untrusted access network, the connection request comprising at least the identification of the visited communication network and an identification of the mobile terminal;
receive a connection response from the gateway node in the home communication network, the connection response comprising at least an indication that connection to the gateway node in the home communication network is not authorized.

7. A mobile terminal as claimed in claim 6, wherein the connection response further comprises an indication to connect to a gateway node in the visited communication network.

8. A mobile terminal as claimed in claim 6, wherein the connection response further comprises an identification of the gateway node in the visited communication network.

9. A mobile terminal as claimed in claim 6, wherein the processing circuitry is further configured to, responsive to receiving the connection response from the gateway node in the home communication network, transmit a subsequent connection request to the gateway node in the visited communication network via the untrusted access network, the subsequent connection request comprising at least the identification of the visited communication network and the identification of the mobile terminal.

10. A mobile terminal comprising:
interfacing circuitry;
processing circuitry configured to, when the mobile terminal is located in a visited communication network while being associated with a home communication network:
receive an identification of the visited communication network;
receive an indication to connect with a gateway node in the visited communication network upon attachment to an untrusted access network;
attach to an untrusted access network;
as a function of the indication to connect with a gateway node in the visited communication network upon attachment to an untrusted access network, transmit a connection request to a gateway node in the visited communication network via the untrusted access network, the connection request comprising at least the identification of the visited communication network and an identification of the mobile terminal;
receive a connection response from the gateway node in the visited communication network, the connection response comprising at least an indication that connection to the gateway node in the home communication network is authorized.

11. A method to handle a connection request in a gateway node of a communication network, the method comprising:
receiving a connection request from a mobile terminal associated with a home communication network but located in a visited communication network, the mobile terminal being attached to an untrusted access network, the connection request comprising at least an identification of the visited communication network and an identification of the mobile terminal;
transmitting an authentication and authorization request to an authentication server, the authentication and authorization request comprising at least the identification of the visited communication network and the identification of the mobile terminal;
receiving an authentication and authorization response from the authentication server, the authentication and authorization response comprising at least an indication as to whether the mobile terminal is authorized to connect to the gateway node;
transmitting a connection response to the mobile terminal, the connection response comprising at least the indication as to whether the mobile terminal is authorized to connect to the gateway node.

12. A method as claimed in claim 11, wherein the gateway node is located in the home communication network, and wherein the indication as to whether the mobile terminal is authorized to connect to the gateway node indicates that the mobile terminal is not authorized to connect to the gateway node.

13. A method as claimed in claim 12, wherein the authentication and authorization response further comprises an indication to connect to a gateway node in the visited communication network.

14. A method as claimed in claim 13, wherein the connection response further comprises the indication to connect to a gateway node in the visited communication network.

15. A method as claimed in claim 13, wherein the authentication and authorization response further comprises an identification of a gateway node in the visited communication network.

16. A method as claimed in claim 15, wherein the connection response further comprises the identification of the gateway node in the visited communication network.

17. A method as claimed in claim 11, wherein the gateway node is located in the visited communication network, and wherein the indication as to whether the mobile terminal is authorized to connect to the gateway node indicates that the mobile terminal is authorized to connect to the gateway node.

18. A gateway node comprising:
interfacing circuitry;
processing circuitry configured to:
receive a connection request from a mobile terminal associated with a home communication network but located in a visited communication network, the mobile terminal being attached to an untrusted access network, the connection request comprising at least an identification of the visited communication network and an identification of the mobile terminal;
transmit an authentication and authorization request to an authentication server, the authentication and authorization request comprising at least the identification of the visited communication network and the identification of the mobile terminal;
receive an authentication and authorization response from the authentication server, the authentication and authorization response comprising at least an indication as to whether the mobile terminal is authorized to connect to the gateway node;
transmit a connection response to the mobile terminal, the connection response comprising at least the indication as to whether the mobile terminal is authorized to connect to the gateway node.

19. A gateway node as claimed in claim 18, wherein when the gateway node is located in the home communication network, the indication as to whether the mobile terminal is authorized to connect to the gateway node indicates that the mobile terminal is not authorized to connect to the gateway node.

20. A gateway node as claimed in claim 19, wherein the authentication and authorization response further comprises an indication to connect to a gateway node in the visited communication network.

21. A gateway node as claimed in claim 20, wherein the connection response further comprises the indication to connect to a gateway node in the visited communication network.

22. A gateway node as claimed in claim 20, wherein the authentication and authorization response further comprises an identification of a gateway node in the visited communication network.

23. A gateway node as claimed in claim 22, wherein the connection response further comprises the identification of the gateway node in the visited communication network.

24. A gateway node as claimed in claim 18, wherein when the gateway node is located in the visited network, the indication as to whether the mobile terminal is authorized to connect to the gateway node indicates that the mobile terminal is authorized to connect to the gateway node.

25. A method to handle connection request in an authentication server of a communication network, the method comprising:
receiving an authentication and authorization request originating from a gateway node, the authentication and authorization request comprising at least an identification of a mobile terminal associated with a home communication network but located in a visited communication network, the mobile terminal being attached to an untrusted access network, and an identification of the visited communication network;
determining whether the mobile terminal is authorized to connect to the gateway node based at least in part on the identification of the visited communication network, and at least one connection rule;
transmitting an authentication and authorization response toward the gateway node, the authentication and authorization response comprising at least an indication as to whether the mobile terminal is authorized to connect to the gateway node.

26. A method as claimed in claim 25, wherein the gateway node is located in the home network, and wherein the indication as to whether the mobile terminal is authorized to connect to the gateway node indicates that the mobile terminal is not authorized to connect to the gateway node.

27. A method as claimed in claim 26, wherein the authentication and authorization response further comprises an indication to connect to a gateway node in the visited communication network.

28. A method as claimed in claim 27, wherein the authentication and authorization response further comprises an identification of a gateway node in the visited communication network.

29. A method as claimed in claim 26, further comprising retrieving the at least one connection rule from an authentication server located in the visited network.

30. A method as claimed in claim 25, wherein the gateway node is located in the visited network, and wherein the indication as to whether the mobile terminal is authorized to connect to the gateway node indicates that the mobile terminal is authorized to connect to the gateway node.

31. An authentication server comprising:
interfacing circuitry;
processing circuitry configured to:
receive an authentication and authorization request originating from a gateway node, the authentication and authorization request comprising at least an identification of a mobile terminal associated with a home communication network but located in a visited communication network, the mobile terminal being attached to an untrusted access network, and an identification of the visited communication network;
determine whether the mobile terminal is authorized to connect to the gateway node based at least in part on the identification of the visited communication network, and at least one connection rule;
transmit an authentication and authorization response toward the gateway node, the authentication and authorization response comprising at least an indication as to whether the mobile terminal is authorized to connect to the gateway node.

32. An authentication server as claimed in claim 31, wherein when the gateway node is located in the home network, the indication as to whether the mobile terminal is authorized to connect to the gateway node indicates that the mobile terminal is not authorized to connect to the gateway node.

33. An authentication server as claimed in claim 32, wherein the authentication and authorization response further comprises an indication to connect to a gateway node in the visited communication network.

34. An authentication server as claimed in claim 33, wherein the authentication and authorization response further comprises an identification of a gateway node in the visited communication network.

35. An authentication server as claimed in claim 32, wherein the processing circuitry is further configured to retrieve the at least one connection rule from an authentication server located in the visited communication network.

36. An authentication server as claimed in claim 31, wherein when the gateway node is located in the visited network, the indication as to whether the mobile terminal is authorized to connect to the gateway node indicates that the mobile terminal is authorized to connect to the gateway node.
